(19) United States
(12) Patent Application Publication
(10) Pub. No.: US 2025/0265242 A1
(43) Pub. Date: Aug. 21, 2025

(54) SYSTEMS AND METHODS OF IMPORTING AND PROCESSING AMALGAMATED DATA INTO DATABASES

(71) Applicant: NTT DATA Services, LLC, Plano, TX (US)

(72) Inventors: Guruprasad Ganapathy, Ambasamudram (IN); Kalirajan Lakshmanan, Chennai (IN); Tanvir Khan, Allen, TX (US); Harsh Vinayak, Gurgaon (IN); Dhurai Ganesan, Chennai (IN)

(21) Appl. No.: 18/583,384

(22) Filed: Feb. 21, 2024

(51) Int. Cl. G06F 16/242; G06F 16/2455; G06F 16/25

(52) U.S. Cl. CPC G06F 16/242; G06F 16/2455; G06F 16/258

(57) ABSTRACT

Systems and methods for processing amalgamated data are disclosed. The method includes receiving data having cells organized into at least a plurality of rows and a plurality of columns, identifying a first merged cell in a first column of the plurality of columns, the first merged cell having a first merged-cell value spanning two or more rows of the plurality of rows, exporting the data into a database table representing the plurality of rows and the plurality of columns, the database table including separate unmerged cells in the two or more rows of the first column in place of the first merged cell, generating a database statement to fill at least a portion of the separate unmerged cells with values derived from the first merged-cell value, and executing the database statement.

### TECHNICAL FIELD

The present disclosure relates generally to amalgamated data and more particularly, but not by way of limitation, to systems and methods of importing and processing amalgamated data into databases.

### BACKGROUND

This section provides background information to facilitate a better understanding of the various aspects of the disclosure. It should be understood that the statements in this section of this document are to be read in this light, and not as admissions of prior art.

Complex coding techniques are generally used to export data from a source table into a structured query language (SQL) table and/or database. Once the source table is exported into the SQL table, merged cells from the source table generate blank cells in the SQL table that need to be filled with the correct, corresponding values. In general, large sets of coding statements are generated and executed in order to fill the blank cells in the SQL table. However, these large sets of coding statements contain multiple LOOP functions that lead to slow code execution and increases the time to implement the process of filling in the blank cells in the SQL table.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the disclosure pertains to a method of processing amalgamated data. The method includes receiving data having cells organized into at least a plurality of rows and a plurality of columns, identifying a first merged cell in a first column of the plurality of columns, the first merged cell having a first merged-cell value spanning two or more rows of the plurality of rows, exporting the data into a database table representing the plurality of rows and the plurality of columns, the database table including separate unmerged cells in the two or more rows of the first column in place of the first merged cell, generating a database statement to fill at least a portion of the separate unmerged cells with values derived from the first merged-cell value, and executing the database statement.

In an embodiment, the disclosure pertains to a system for processing amalgamated data having memory at least one processor coupled to the memory and configured to implement a method. The method includes receiving data having cells organized into at least a plurality of rows and a plurality of columns, identifying a first merged cell in a first column of the plurality of columns, the first merged cell having a first merged-cell value spanning two or more rows of the plurality of rows, exporting the data into a database table representing the plurality of rows and the plurality of columns, the database table including separate unmerged cells in the two or more rows of the first column in place of the first merged cell, generating a database statement to fill at least a portion of the separate unmerged cells with values derived from the first merged-cell value, and executing the database statement.

In an embodiment, the disclosure pertains to a computer-program product having a non-transitory computer-usable medium having computer-readable program code embodied therein, the computer-readable program code adapted to be executed to implement a method for processing amalgamated data. The method includes receiving data having cells organized into at least a plurality of rows and a plurality of columns, identifying a first merged cell in a first column of the plurality of columns, the first merged cell having a first merged-cell value spanning two or more rows of the plurality of rows, exporting the data into a database table representing the plurality of rows and the plurality of columns, the database table including separate unmerged cells in the two or more rows of the first column in place of the first merged cell, generating a database statement to fill at least a portion of the separate unmerged cells with values derived from the first merged-cell value, and executing the database statement.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates an example system for processing amalgamated data according to aspects of the disclosure.

FIG. 2 illustrates an example computer system according to aspects of the disclosure.

FIG. 3 illustrates an example of data having merged cells arranged in a plurality of rows and a plurality of columns according to aspects of the disclosure.

FIG. 4A illustrates an example of the data from FIG. 3 exported into a database having blank rows as a result of exporting data having merged cells according to aspects of the disclosure.

FIG. 4B illustrates an example of the exported data of FIG. 4A after a database statement has been executed on the exported data according to aspects of the disclosure.

FIG. 5 illustrates an example method of replacing predetermined values with correct, corresponding values from merged cells according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Generally, data may be exported from a source table to a destination table using MICROSOFT C# and/or MICROSOFT.NET. In various instances, the source table may be data in the form of a spreadsheet and the destination table may be a structured query language (SQL) table. In such instances, exporting a spreadsheet into an SQL table and/or database usually requires additional functions to be performed (e.g., INSERT, UPDATE, and/or DELETE) such that the SQL table properly reflects the data values in the corresponding source table, for example, when the source table contains merged cells. As used herein, an SQL table may be representative of a specific SQL table (SQL table) and/or an SQL database, and each term may be used interchangeably as understood by context to those of ordinary skill in the art.

In certain instances, when the merged cells from the source table are exported into the destination table, then MICROSOFT C# and/or MICROSOFT.NET code needs to be executed to fill in data in corresponding the SQL table. For example, when data from a MICROSOFT EXCEL file is exported into an SQL table, the merged cells that existed in the MICROSOFT EXCEL file are imported as NULL (or blank) cells in the SQL table. This means only the first cell of the merged cells has the data from the MICROSOFT EXCEL file, while the remaining cells have NULL (or blank) values. In most instances, these NULL (or blank) cells need to be filled in with the merged cell data in SQL table. As used herein, the term NULL may refer to a blank value, no value, “0”, and/or combinations of the same and like. While the disclosure generally provides examples by way of NULL (or blank) values, it should be understood that any predetermined value may be substituted without deviating from the scope of this disclosure.

Complex coding techniques are generally used to export data from a source table into an SQL table. Once the source table is exported into the SQL table, merged cells from the source table generate NULL (or blank) cells in the SQL table, as previously described, that need to be filled with the correct, corresponding values. In general, large sets of coding statements are generated and executed in order to fill the NULL (or blank) cells in the SQL table. However, these large sets of coding statements contain multiple LOOP functions that lead to slow code execution and increase the time to implement the process of filling in the blank cells in the SQL table. This is exacerbated when large amounts of data from single and/or multiple data repositories need to be imported into the SQL table (or multiple SQL tables and/or servers). In some instances, various formats of MICROSOFT EXCEL may be imported into the SQL table, and thus, a need exists to generate code and/or logic according to each MICROSOFT EXCEL format.

Accordingly, there is a need for exporting data, such as source tables (e.g., MICROSOFT EXCEL data), into SQL tables without the need for MICROSOFT C# and/or MICROSOFT.NET code to fill in the data of merged cells into NULL (or blank) of the SQL table. Additionally, there is a need for exporting source tables (e.g., MICROSOFT EXCEL data) into SQL tables using SQL queries to fill the data of merged cells in the SQL table, rather than relying on complex coding techniques.

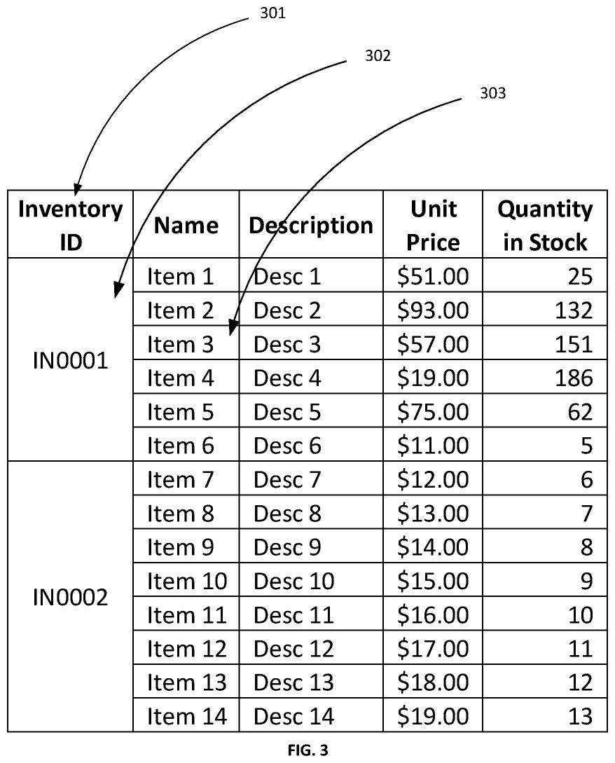

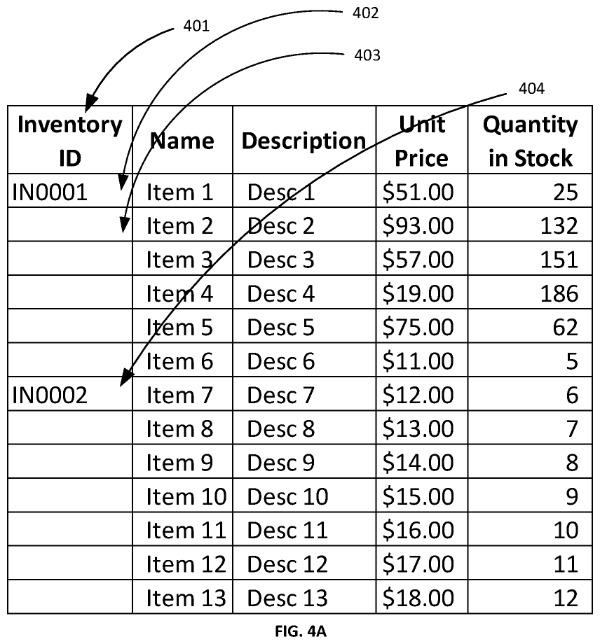

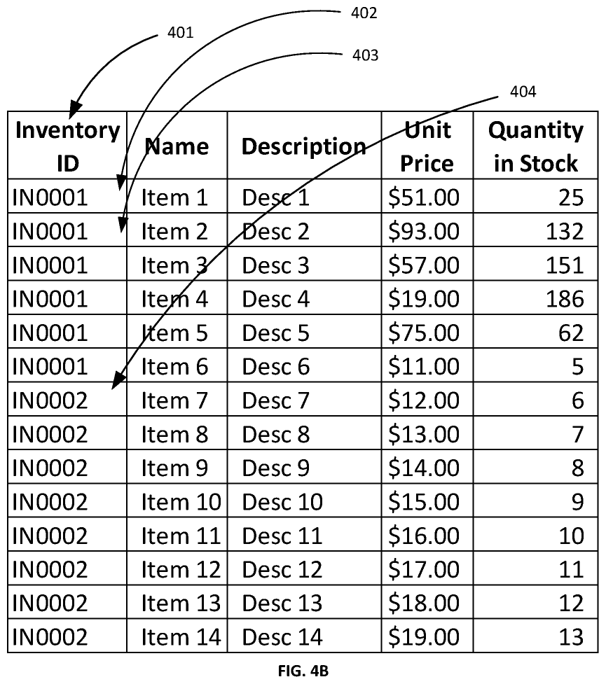

As previously discussed, complex coding techniques are generally used to export data from source tables into SQL tables. These coding statements may include, without limitation, MICROSOFT C# and/or MICROSOFT.NET source code, which are often complex in execution. In certain embodiments, the source table may include a MICROSOFT EXCEL spreadsheet and the destination table may include an SQL table. In some embodiments, the source table includes of a number of merged cells, which when exporting into the SQL table may be split up as NULL (or blank) cells (e.g., blank cells or cells filled with a predetermined value). In such embodiments, the split cells have NULL (or blank) values, except the first cell of the merged cells, as described below relative to FIGS. 3-4.

As stated previously, the NULL (or blank) cells may need to be filled with the merged cell data in the SQL table. As will be discussed in further detail below, a set of SQL queries may be generated and executed to update the NULL (or blank) cell values in the SQL table. In certain embodiments, an SQL query may be used to import the MICROSOFT EXCEL data to avoid LOOP statements (i.e., no looping involved in execution of code to fill the NULL (or blank) cells), thus the NULL (or blank) cells are filled in less time. In certain embodiments, a single SQL query may be executed regardless of the format of the MICROSOFT EXCEL data, and also with respect to the number of columns that need to be filled. In this manner, the NULL (or blank) cells may be easily filled with the previous cell values. As SQL queries are used to fill the NULL (or blank) values by adopting the previous, non-NULL (or non-blank) cell value for any type of MICROSOFT EXCEL format, time consumed by a developer and/or automated processing system may be substantially reduced.

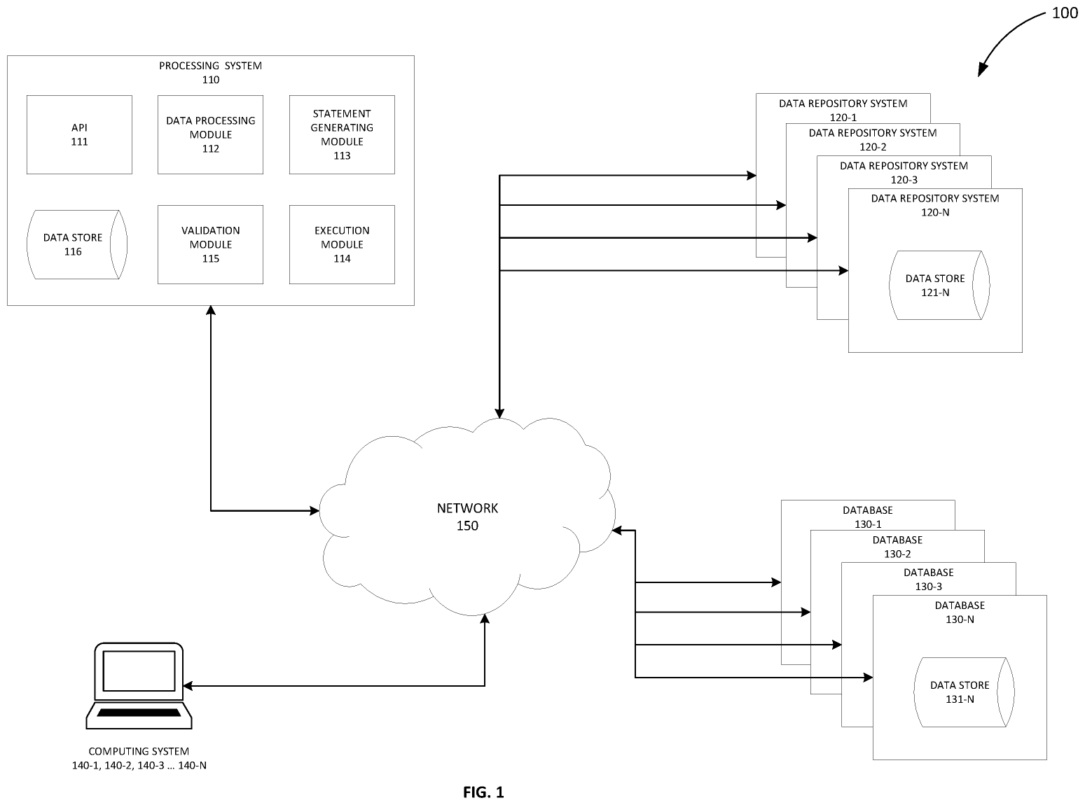

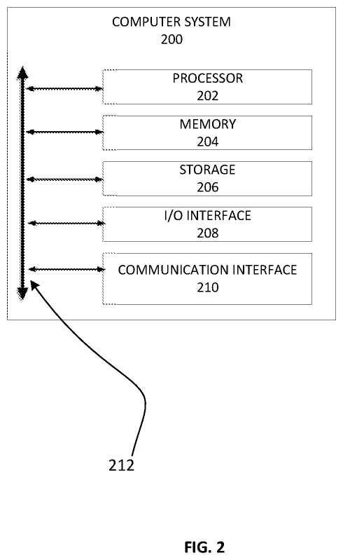

FIG. 1 illustrates an example system 100 for processing amalgamated data according to aspects of the disclosure. In general, system 100 may include, for example, a processing system 110, data repository systems 120-1, 120-2, 120-3 . . . 120-N (collectively referred to as “data repository system 120”) each having a data store 121-N (collectively referred to as data store 121), database 130-1, 130-2, 130-3 . . . 130-N (collectively referred to database 130) each having a data store 131-N (collectively referred to as data store 131), and computing system 140-1, 140-2, 140-3 . . . 140-N (collectively referred to as computing system 140) each communicatively coupled via a network 150 (e.g., the Internet, a public cloud system, a private cloud system, and the like). In certain embodiments, each of the processing system 110, data repository system 120, and/or the database 130 may include a computer system 200 as described further in FIG. 2. Furthermore, in certain embodiments, computing system 140 may be representative of computer system 200 as described in further detain in FIG. 2.

As shown in FIG. 1, the processing system 110 may include an application programming interface (API) 111, a data processing module 112, a statement generation module 113, an execution module 114, a validation module 115, and data store 116. In certain embodiments, the data store 116 may be representative of storage 206 as described in FIG. 2. While the processing system 110 is described as a single processing system 110, in various embodiments, the processing system 110 may include a plurality of processing systems 110. For example, the system 100 may include a processing system 110 for each tenant (e.g., companies, institutions, and the like) on the network 150 (e.g., a private and/or public cloud system) or within an organization operating on the network 150. In such embodiments, each processing system 110 can interact with corresponding data repository systems 120, databases 130, and computing systems 140 over the network 150. In various embodiments, when system 100 includes a plurality of processing systems 110, the network 150 may be a plurality of private and/or public cloud systems for each tenant.

In certain embodiments, the processing system 110 (e.g., the data processing module 112) may access data from the data repository system 120 from data store 121 of, for example, an organization, via the API 111. In some embodiments, the data processing module 112 retrieves the data from the data repository system 120 responsive to a user request initiated from, for example, the computing system 140. In some embodiments, the data repository system 120 periodically sends the data to the processing system 110. Additionally and/or alternatively, in certain embodiments, the data processing module 112 may receive data from the computing system 140.

In some embodiments, the data is stored in data store 116 after the data is accessed. In certain embodiments, the data may include data in various data formats. For example, the data may have formats including, without limitation, spreadsheet formats (e.g., MICROSOFT EXCEL data, LIBREOFFICE CALC data, OPENOFFICE CALC data, APPLE NUMBERS data, GOOGLE SHEETS data, and the like), comma-separated values, tab separated-values, standard generalized markup language (SGML), extensible markup language (XML), YAML AIN'T MARKUP LANGUAGE (YAML), JAVASCRIPT object notation (JSON), plan text, rich-text, and combinations of the same and like.

In certain embodiments, the data contains merged cells within the data (e.g., MICROSOFT EXCEL) or merged cells upon processing and/or representation of the data (e.g., XML elements mapped to an XML map). While the following data formats have been illustrated, it should be noted that the disclosure envisions any form of data known to a person of ordinary skill in the art that has, or can be manipulated to have, merged data to form one cell encompassing the data. As used herein, a merged cell may refer to combining two or more adjacent cells either vertically, horizontally, or both (e.g., in MICROSOFT EXCEL spreadsheets). In certain embodiments, merging cells may be used when a heading or title has to be centered over an area of a worksheet, spreadsheet, and/or other tabular or non-tabular data.

In certain embodiments, the processing system 110 (e.g., the statement generating module 113) may access received data and identify predetermined values (e.g., NULL or blank values) within the data. For example, the statement generating module 113 may review a MICROSOFT EXCEL spreadsheet and identify one or more merged cells, discussed in further detail below with respect to FIGS. 3-5. In certain embodiments, the statement generating module 113 may generate a statement (e.g., an SQL statement in response to identifying one or more merged cells). As an example, previously, MICROSOFT C# and/or MICROSOFT.NET was used for extracting data from MICROSOFT EXCEL, which included a number of LOOP statements. To overcome the use of LOOP statements, embodiments of the present disclosure may generate statements to extract data to execute on database 130 without the need of using LOOP statements. For instance, in certain embodiments, responsive to processing data illustrative of, for example, FIG. 3, the statement generating module 113 may generate a statement as shown below:

Statement 1.

```
DECLARE @Batchid int = 1
DECLARE @InventoryID nvarchar(MAX)
UPDATE [dbo].[ImportInventoryFile]
SET
  @InventoryID = COALESCE(InventoryID, @InventoryID),
  InventoryID = REPLACE(REPLACE(RTRIM(LTRIM(COALESCE(InventoryID,
    @InventoryID))), CHAR(13),‘ ’), CHAR(10),‘ ’)
WHERE Batchid = @Batchid
```

In certain embodiments, a statement is generated for each merged cell identified in the data. In some embodiments, a plurality of statements is generated for each merged cell in the data. While Statement 1, shown above, represents values that will be discussed in further detail below with respect to FIGS. 3-4, a person of ordinary skill in the art will recognize that various portions of Statement 1 may be altered to accommodate the data that is to be exported into database 130. For example, and not by way of limitation, certain variables may be altered to represent merged cell data within the data (e.g., InventoryID may be altered in Statement 1).

In certain embodiments, the processing system 110 (e.g., the execution module 114) may execute the statement (e.g., Statement 1) after exporting the data into database 130. In some embodiments, the execution module 114 exports the data to the database 130. In various embodiments, the data processing module 112 and/or the computing system 140 exports the data into database 130. In some embodiments, after the data is exported to the database 130, the execution module 114 executes the statement (e.g., Statement 1) on the data exported to the database 130. In various embodiments, the computing system 140 executes the statement (e.g., Statement 1) on the database 130. In certain embodiments, the statement is executed via a database query. In some embodiments, the statement is executed as part of a batch script when exporting the data to database 130. In certain embodiments, a statement is generated and provided to a user (e.g., a user of computing system 140) to be executed (e.g., manually) on database 130.

In certain embodiments, the processing system 110 (e.g., the validation module 115) may validate database 130 after exporting the data into database 130 and executing the statement (e.g., Statement 1). In certain embodiments, the validation module 115 may validate that there no NULL (or blank) cells within database 130 after execution. In some embodiments, the validation module 115 may validate that there are no cells within database 130 that include certain predetermined values (e.g., a NULL (or blank) value, or other value).

As shown in FIG. 1, the system 100 may include one or more data repository systems 120. In certain embodiments, the data repository system 120 may include a computer system 200 as described further in FIG. 2. In certain embodiments, the data repository system 120 may be a distributed data repository system 120. In certain embodiments, each data repository system 120 may include a data store 212, such as storage 206 as described further in FIG. 2. In certain embodiments, the data repository system 120 may include, without limitation, network attached storage (NAS), storage area network (SAN), public and/or private cloud storage, local on-premises storage, hybrid cloud storage (e.g., remote and on-premises), and combinations of the same and like. In certain embodiments, the data to be received is stored within data store 121 of the data repository system 120.

As shown in FIG. 1, the system 100 may include one or more databases 130. In certain embodiments, the database 130 may include a computer system 200 as described further in FIG. 2. In certain embodiments, the database 130 may be a distributed database 130. In certain embodiments, each the database 130 may include a data store 131, such as storage 206 as described further in FIG. 2. In certain embodiments, the database 130 may include databases and/or database servers. By way of example and not limitation, the databases and/or servers may include MICROSOFT SQL databases and/or servers, MYSQL databases and/or servers, POSTGRESQL databases and/or servers, MongoDB databases and/or servers, SQLITE databases and/or servers, ORACLE DATABASE databases and/or servers, NOSQL databases and/or servers, and combinations of the same and like. In certain embodiments, databases and/or tables (e.g., SQL tables) are stored in the data store 131 of the database 130.

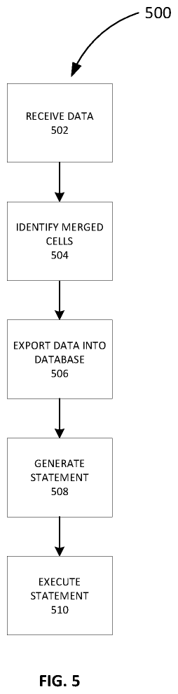

As shown in FIG. 1, the system 100 may include one or more computing systems 140. In certain embodiments, computing system 140 may be representative of computer system 200 as described in further detain in FIG. 2. In various embodiments, the computer system 140 may communicate with one or more of the processing system 110, the data repository system 120, and/or the database 130. The computing system 160, in certain embodiments, may be used to initiate procedures, such as those discussed below relative to FIG. 5, by accessing the processing system 110, the data repository system 120, and/or the database 130. Additionally and/or alternatively, the computing system 160, in certain embodiments, may be used to initiate procedures, such as those discussed below relative to FIG. 5, by accessing an interface of the processing system 110, the data repository system 120, and/or the database 130. In some embodiments, the interface may include, without limitation, a graphical user interface (GUI) operable to access the processing system 110, the data repository system 120, and/or the database 130, a frontend (e.g., a website frontend) for the processing system 110, the data repository system 120, and/or the database 130, a computer program operable to interact with the processing system 110, the data repository system 120, and/or the database 130, and combinations of the same and like.

It should be noted that while each module of the processing system 110 may be operated independently, each module within the processing system 110 may work in parallel or in tandem with other modules within the processing system 110. As such, each module within the processing system 110 can independently, or in combination, perform similar and/or related tasks, and are described as separate modules for illustrative purposes only. Additionally, while the processing system 110 is described relative to FIG. 1 as including the API 111, the data processing module 112, the statement generating module 113, the execution module 114, and the validation module 115, in certain embodiments, the above described modules may be expanded into more modules, or reduced into fewer modules. In such embodiments, each module of the processing system 110 may be expanded into multiple modules or confined to fewer modules without deviating from the scope of the disclosure. Additionally, while FIG. 1 is described relative to a single processing system 110, the processing system 110 may be expanded into multiple processing systems 110 and/or a plurality of processing systems 110 without deviating from the scope of the disclosure.

Furthermore, while FIG. 1 was described relative to modules within the processing system 110, in certain embodiments, the feature outlined above may be exhibited on the computing system 140 without the processing system 110. In such embodiments, the computing system 140 may receive data (e.g., from data repository system 120), review and/or analyze the data, generate a statement in response to merged cells being in the data, export the data to a database (e.g., database 130), execute the statement on the database (e.g., database 130), and/or validate the database after the statement has been executed.

FIG. 2 illustrates an example computer system 200. Computer system 200 may include a processor 202, memory 204, storage 206, an input/output (I/O) interface 208, a communication interface 210, and a bus 212. Although this disclosure describes one example computer system including specified components in a particular arrangement, this disclosure contemplates any suitable computer system with any suitable number of any suitable components in any suitable arrangement. As an example and not by way of limitation, computer system 200 may be an embedded computer system, a system-on-chip, a single-board computer system, a desktop computer system, a laptop or notebook computer system, a mainframe, a mesh of computer systems, a mobile telephone, a personal digital assistant, a server computing system, a tablet computer system, or a combination of two or more of these. Where appropriate, computer system 200 may include one or more computer systems 200; be unitary or distributed, span multiple locations, machines, or data centers; or reside in a cloud, which may include one or more cloud components in one or more networks. Where appropriate, computer system 200 may perform, at different times or at different locations, in real time or in batch mode, one or more steps of one or more methods described or illustrated herein.

Processor 202 may include hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. Processor 202 may include one or more internal caches for data, instructions, or addresses.

In particular embodiments, memory 204 includes main memory for storing instructions for processor 202 to execute or data for processor 202 to operate on. In particular embodiments, one or more memory management units (MMUs) reside between processor 202 and memory 204 and facilitate accesses to memory 204 requested by processor 202. In particular embodiments, memory 204 includes random access memory (RAM). This disclosure contemplates any suitable RAM.

In particular embodiments, storage 206 includes mass storage for data or instructions. As an example and not by way of limitation, storage 206 may include a removable disk drive, flash memory, an optical disc, a magneto-optical disc, magnetic tape, or a Universal Serial Bus (USB) drive or two or more of these. Storage 206 may include removable or fixed media and may be internal or external to computer system 200. Storage 206 may include any suitable form of non-volatile, solid-state memory or read-only memory (ROM).

In particular embodiments, I/O interface 208 includes hardware, software, or both, providing one or more interfaces for communication between computer system 200 and one or more input and/or output (I/O) devices. Computer system 200 may be communicably connected to one or more I/O devices. An input device may include any suitable device for converting volitional user input into digital signals that may be processed by computer system 200, such as, by way of example and not limitation, a touch screen, a microphone, a joystick, a scroll wheel, a button, a toggle, a switch, a keyboard, a mouse, a touchpad, or a dial. An input device may include one or more sensors for capturing different types of information. An output device may include devices designed to receive digital signals from computer system 200 and convert them to an output format, such as, by way of example and not limitation, speakers, headphones, a display screen, a monitor, a heads-up display, another suitable output device, or a combination thereof. This disclosure contemplates any suitable I/O devices and any suitable I/O interfaces 208 for them. I/O interface 208 may include one or more I/O interfaces 208, where appropriate.

In particular embodiments, communication interface 210 includes hardware, software, or both, providing one or more interfaces for data communication between computer system 200 and one or more other computer systems 200 or one or more networks. Communication interface 210 may include one or more interfaces to a controller area network (CAN) or to a local interconnect network (LIN). Communication interface 210 may include one or more of a serial peripheral interface (SPI) or an isolated serial peripheral interface (isoSPI). In some embodiments, communication interface 210 may include a network interface controller (NIC) or network adapter for communicating with an Ethernet or other wire-based network or a wireless NIC (WNIC) or wireless adapter for communicating with a wireless network, such as a WI-FI network or a cellular network.

In particular embodiments, bus 212 includes hardware, software, or both, coupling components of computer system 200 to each other. Bus 212 may include any suitable bus, as well as one or more buses 212, where appropriate. Although this disclosure describes a particular bus, any suitable bus or interconnect is contemplated.

Herein, a computer-readable non-transitory storage medium or media may include one or more semiconductor-based or other integrated circuits (ICs) (such, as for example, field-programmable gate arrays or application-specific ICs), hard disk drives, hybrid hard drives, optical discs, optical disc drives, magneto-optical discs, magneto-optical drives, solid-state drives, RAM drives, any other suitable computer-readable non-transitory storage media, or any suitable combination. A computer-readable non-transitory storage medium may be volatile, non-volatile, or a combination of volatile and non-volatile, where appropriate.

FIG. 3 illustrates an example of data having merged cells arranged in a plurality of rows and a plurality of columns according to aspects of the disclosure. FIG. 3, in certain embodiments, is representative of data to be exported into an SQL database originating from a spreadsheet. The spreadsheet data has a column identifier 301 (Inventory ID), a merged cell 302 (IN0001), and rows corresponding to the merged cell 302. As illustrated in FIG. 3, the merged cell 302 has a value of INV0001 that represents Item 1, Item 2, Item 3 (303), Item 4, Item 5, and Item 6 (collectively referred to as corresponding rows 303) in the spreadsheet. The corresponding rows 303 each has data values assigned to them, for example, name, description, unit price, and quantity in stock. As shown in FIG. 3, the merged cell 302 represents the column identifier 301 for each of the corresponding rows 303. Stated differently, each corresponding row 303 has the same value associated with the column identifier 301, illustrated as INV0001 in FIG. 3 (merged cell 302).

FIG. 4A illustrates an example of the data from FIG. 3 exported into a database having blank rows as a result of exporting data having merged cells according to aspects of the disclosure. FIG. 4A, in certain embodiments, is representative of the data from FIG. 3 exported into an SQL database. In certain embodiments, FIG. 4A illustrates the spreadsheet data of FIG. 3 after the data is exported into an SQL table using a MICROSOFT C# and/or MICROSOFT.NET bulk upload command. As shown in FIG. 4A, the SQL table includes a column identifier 401 corresponding to column identifier 301 of FIG. 3. However, after exporting the data of FIG. 3 into an SQL database, merged cell 302 becomes unmerged, resulting in one or more cells. FIG. 4A, shows that a first cell 402 has a corresponding value representative of the merged cell 302 and one or more blank cells 403. The one or more blank cells 403 repeat in the SQL table until a second unmerged cell 404 is generated from a second merged cell. As shown in FIG. 4A, the unmerged cells (e.g., 402 and 403) represent the column identifier 401 for each corresponding row, though not each cell has the corresponding value. Stated differently, each unmerged cell (e.g., 402 and 403) has a value associated with the column identifier 401, illustrated as INV0001 in FIG. 4A; however, the first cell 402 has a value corresponding to the value of the merged cell 302 of FIG. 3, while the one or more blank cells 403 are NULL (or blank).

FIG. 4B illustrates an example of the exported data of FIG. 4A after a database statement of the disclosure has been executed on the exported data according to aspects of the disclosure. For example, the data from FIG. 4A may have an SQL statement (e.g., Statement 2, shown below) executed on the data.

Statement 2.

@InventoryID = COALESCE(InventoryID, @InventoryID)
InventoryID = REPLACE(REPLACE(RTRIM(LTRIM(COALESCE(InventoryID,
@InventoryID))), CHAR(13),‘ ’), CHAR(10),‘ ’)

In certain embodiments, FIG. 4B illustrates the exported data of FIG. 4A once Statement 2, shown above, has been executed. As shown in FIG. 4B, the SQL table retains the column identifier 401 corresponding to column identifier 301 of FIG. 3. However, after executing Statement 2 on the SQL table, the first cell 402 remains there same (IN0001) and the one or more blank cells 403 are populated with the data from the first cell 402 (IN0001). The one or more blank cells 403 are each filled until the second unmerged cell 404 is encountered. As shown in FIG. 4B, the unmerged cells (e.g., 402 and 403) represent the column identifier 401 for each corresponding row, and after execution of Statement 2, each has the correct, corresponding values. Stated differently, each unmerged cell (e.g., 402 and 403) has the correct value associated with the column identifier 401, illustrated as INV0001 in FIG. 4A-4B, thus no NULL (or blank) cells remain in the SQL table.

While FIGS. 4A-4B illustrate the one or more blank cells 403 as being NULL (or blank), in certain embodiments, the one or more blank cells 403 may be filled with a predetermined value that may or may not be a NULL (or blank) value.

FIG. 5 illustrates an example of a process 500 for replacing predetermined values with correct, corresponding values from merged cells according to aspects of the disclosure. In certain embodiments, the process 500 is performed by one or more modules within the processing system 110.

At block 502, the processing system 110 (e.g., the data processing module 112) receives data, as described above with respect to FIG. 1. In some embodiments, at block 502, the data processing module 112 receives data having cells organized into at least a plurality of rows and a plurality of columns.

In certain embodiments, the data includes tabular data arranged in rows and columns and includes one or more merged cells (e.g., data as illustrated in FIG. 3). In some embodiments, the data processing module 112 receives the data from the data repository system 120 responsive to a user request initiated from, for example, the computing system 160. In some embodiments, at least one cell of the separate unmerged cells includes a predetermined value. In some embodiments, the predetermined value includes a NULL (or blank) value. In some embodiments, the plurality of columns includes a vertical array of data.

At block 504, the processing system 110 (e.g., the statement generating module 113) may access received data and identify predetermined values (e.g., NULL (or blank) values, or predetermined values) within the data, as described with respect to FIG. 1. In some embodiments, at block 504, the statement generating module 113 identifies a first merged cell in a first column of the plurality of columns. In certain embodiments, the first merged cell includes a first merged-cell value spanning two or more rows of the plurality of rows.

At block 506, the processing system 110 (e.g., the execution module 114) may export the data into a database. In some embodiments, the data may be exported to database 130. In some embodiments, at block 506, the execution module 114 exports the data into a database table representing the plurality of rows and the plurality of columns. In some embodiments, the database table includes separate unmerged cells in the two or more rows of the first column in place of the first merged cell.

In certain embodiments, the data may be exported to one or more databases 130. In certain embodiments, data is exported to the database 130 using, for example, MICROSOFT C# and/or MICROSOFT.NET programming statements. In certain embodiments, data is batch and/or bulk exported to one or more databases 130. In certain embodiments, data within the database 130 is representative of data as illustrated in FIG. 4A (e.g., merged cells being unmerged and resulting in NULL (or blank) values).

At block 508, the processing system 110 (e.g., the statement generation module 113) may generate a statement, as described with respect to FIG. 1. In certain embodiments, at block 508, the statement generation module 113 generates a database statement to fill at least a portion of the separate unmerged cells with values derived from the first merged-cell value. In some embodiments, the database statement includes and SQL database query.

In certain embodiments, the generating includes determining, from the separate unmerged cells, one or more cells that include the predetermined value (e.g., NULL (or bank) value), determining, from the separate unmerged cells, one or more cells that include a non-predetermined value (e.g., a non-NULL (or non-blank) value), and determining, from the separate unmerged cells, a specific value for each predetermined value based, at least in part, on the non-predetermined value. In some embodiments, the non-predetermined value is based, at least in part, on the first merged cell.

In certain embodiments, the generated statement includes an SQL statement. In some embodiments, the SQL statement includes one or more COALESCE and/or REPLACE functions. For example, in certain embodiments, the SQL statement includes a query for specifying the cells that need to be updated using a COALESCE function, then a following SQL query includes a query for replacing (e.g., REPLACE function) the NULL (or blank) cells with values of merged cells as existed in received data. In certain embodiments, the generated statement does not include a LOOP function. In certain embodiments, the generated statement may include, for example, Statement 1 and/or Statement 2, shown above.

At block 510, the processing system 110 (e.g., the execution module 114) may execute the statement (e.g., the database statement) generated at block 508, as described with respect to FIG. 1. In certain embodiments, the execution module 114 executes the statement on data within the database 130. In certain embodiments, data within the database 130 becomes representative of data as illustrated in FIG. 4B (e.g., unmerged cells being filled with correct, corresponding values).

In certain embodiments, the statement generated at block 508 is executed such that each NULL (or blank) cell is replaced and/or filled with the correct, corresponding value, as described with respect to FIGS. 3-4. In certain embodiments, after the statement is executed, the processing system 110 (e.g., the validation module 115) may further validate the data within the database. In some embodiments, the validation may include, without limitation, confirming that the database has no NULL (or blank) cells and/or other pre-determined values.

While process 500 is described with various modules performing functionality in a particular sequence, it is to be understood that any component within the system 100 may perform any of the foregoing functionality in various sequences, in tandem, and/or in parallel, and may be performed in real-time, manually, and/or at specific time intervals (e.g., every 5, 10, 15, 20, 30, 45, or 60 minutes). In certain embodiments, various blocks within the process 500 can be omitted. Additionally, process 500 may be performed for a data input or for data inputs, in tandem or in parallel, and each block and/or process can be performed as outlined above with respect to FIG. 1. Permutations of the process 500 are readily envisioned without deviating from the scope of the disclosure. For example, various blocks within process 500 may be omitted, combined with other blocks, or have additional blocks added without deviating from the scope of the disclosure.

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those of ordinary skill in the art may better understand the aspects of the disclosure. Those of ordinary skill in the art should appreciate that they may readily use the disclosure as a basis for designing or modifying other processes and structures for carrying out the same purposes and/or achieving the same advantages of the embodiments introduced herein. Those of ordinary skill in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements, and/or states are included or are to be performed in any particular embodiment.

While the above detailed description has shown, described, and pointed out novel features as applied to various embodiments, it will be understood that various omissions, substitutions, and changes in the form and details of the embodiments illustrated can be made without departing from the spirit of the disclosure. As will be recognized, the various embodiments described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

1. A method of processing amalgamated data, the method comprising, by a computer system:
receiving data comprising cells organized into at least a plurality of rows and a plurality of columns;
identifying a first merged cell in a first column of the plurality of columns, the first merged cell comprising a first merged-cell value spanning two or more rows of the plurality of rows;
exporting the data into a database table representing the plurality of rows and the plurality of columns such that the database table includes separate unmerged cells in the two or more rows of the first column in place of the first merged cell, wherein:
a first unmerged cell of the separate unmerged cells comprises the first merged-cell value; and
one or more other cells of the separate unmerged cells comprise a predetermined value different from the first merged-cell value;
generating a database statement operable to replace the predetermined value in each of the one or more other cells of the separate unmerged cells with a specific value derived from the first merged-cell value; and
executing the database statement on the database table to replace the predetermined value in each of the one or more other cells of the separate unmerged cells with the specific value derived from the first merged-cell value.

2. The method of claim 1, wherein the database statement excludes a loop function.

3. The method of claim 1, wherein the generating comprises:
determining, from the separate unmerged cells, the first unmerged cell that comprises the predetermined value;
determining, from the separate unmerged cells, the one or more other cells that comprise the first merged-cell value; and
determining, from the separate unmerged cells, the specific value for each of the one or more other cells based, at least in part, on the first merged-cell value.

4. The method of claim 1, wherein the specific value for each of the one or more other cells comprises the first merged-cell value.

5. The method of claim 1, wherein the predetermined value comprises at least one of a NULL value or a blank value.

6. The method of claim 1, wherein the plurality of columns comprises a vertical array of data.

7. The method of claim 1, wherein the database statement comprises a structured query language (SQL) database query.

8. A system for processing amalgamated data, comprising:
memory; and
at least one processor coupled to the memory and configured to implement a method, the method comprising:
receiving data comprising cells organized into at least a plurality of rows and a plurality of columns;
identifying a first merged cell in a first column of the plurality of columns, the first merged cell comprising a first merged-cell value spanning two or more rows of the plurality of rows;
exporting the data into a database table representing the plurality of rows and the plurality of columns such that the database table includes separate unmerged cells in the two or more rows of the first column in place of the first merged cell, wherein:
a first unmerged cell of the separate unmerged cells comprises the first merged-cell value; and
one or more other cells of the separate unmerged cells comprise a predetermined value different from the first merged-cell value;
generating a database statement operable to replace the predetermined value in each of the one or more other cells of the separate unmerged cells with a specific value derived from the first merged-cell value; and
executing the database statement on the database table to replace the predetermined value in each of the one or more other cells of the separate unmerged cells with the specific value derived from the first merged-cell value.

9. The system of claim 8, wherein the database statement excludes a loop function.

10. The system of claim 8, wherein the generating comprises:
determining, from the separate unmerged cells, the first unmerged cell that comprises the predetermined value;
determining, from the separate unmerged cells, the one or more other cells that comprise the first merged-cell value; and
determining, from the separate unmerged cells, the specific value for each of the one or more other cells based, at least in part, on the first merged-cell value.

11. The system of claim 8, wherein the specific value for each of the one or more other cells comprises the first merged-cell value.

12. The system of claim 8, wherein the predetermined value comprises at least one of a NULL value or a blank value.

13. The system of claim 8, wherein the plurality of columns comprises a vertical array of data.

14. The system of claim 8, wherein the database statement comprises a structured query language (SQL) database query.

15. A computer-program product comprising a non-transitory computer-usable medium having computer-readable program code embodied therein, the computer-readable program code adapted to be executed to implement a method for processing amalgamated data comprising:
receiving data comprising cells organized into at least a plurality of rows and a plurality of columns;
identifying a first merged cell in a first column of the plurality of columns, the first merged cell comprising a first merged-cell value spanning two or more rows of the plurality of rows;
exporting the data into a database table representing the plurality of rows and the plurality of columns such that the database table includes separate unmerged cells in the two or more rows of the first column in place of the first merged cell, wherein:
a first unmerged cell of the separate unmerged cells comprises the first merged-cell value; and
one or more other cells of the separate unmerged cells comprise a predetermined value different from the first merged-cell value;
generating a database statement operable to replace the predetermined value in each of the one or more other cells of the separate unmerged cells with a specific value derived from the first merged-cell value; and
executing the database statement on the database table to replace the predetermined value in each of the one or more other cells of the separate unmerged cells with the specific value derived from the first merged-cell value.

16. The computer-program product of claim 15, wherein the database statement excludes a loop function.

17. The computer-program product of claim 15, wherein the generating comprises:
determining, from the separate unmerged cells, the first unmerged cell that comprises the predetermined value;
determining, from the separate unmerged cells, the one or more other cells that comprise the first merged-cell value; and
determining, from the separate unmerged cells, the specific value for each of the one or more other cells based, at least in part, on the first merged-cell value.

18. The computer-program product of claim 15, wherein the specific value for each of the one or more other cells comprises the first merged-cell value.

19. The computer-program product of claim 15, wherein the plurality of columns comprises a vertical array of data.

20. The computer-program product of claim 15, wherein the database statement comprises a structured query language (SQL) database query.
